(19) United States
(12) Patent Application Publication
(10) Pub. No.: US 2017/0315648 A1
(43) Pub. Date: Nov. 2, 2017

(54) DUAL-SCREEN TABLET COMPUTER AND DISPLAY AND TOUCH CONTROL METHOD THEREFOR

(71) Applicant: ASLL ELECTRINICS TECHNOLOGY LIMITED COMPANY, Jiangsu (CN)

(72) Inventors: Golden Lin, Jiangsu (CN); Castle Zhang, Jiangsu (CN)

(73) Assignee: ASLL ELECTRONICS TECHNOLOGY LIMITED COMPANY, Jiangsu (CN)

(21) Appl. No.: 15/651,238

(22) Filed: Jul. 17, 2017

Related U.S. Application Data
(63) Continuation of application No. PCT/CN2016/070699, filed on Jan. 12, 2016.

(30) Foreign Application Priority Data
Jan. 20, 2015 (CN) 201510027254.7

(51) Int. Cl. G06F 3/041; G06F 1/16

(52) U.S. Cl. CPC G06F 3/0412; G06F 1/16; G06F 1/1647

(57) ABSTRACT

Provided are a dual-screen tablet computer and a display and touch control method therefor. The dual-screen tablet computer includes a first display screen, a second display screen, a first touch screen and a second touch screen. The first touch screen is bonded to the first display screen. The second touch screen is bonded to the second display screen. The first display screen and the second display screen are connected to each other through a rotating shaft or a hinge. The first touch screen and the second touch screen are electrically connected to one single touch main control module simultaneously. When the display mode of the dual-screen tablet computer is configured to the expanded display mode, different touch screens can be operated simultaneously.

### CROSS-REFERENCES TO RELATED APPLICATIONS

The application is a continuation of International Application No. PCT/CN2016/070699, filed on Jan. 12, 2016, which claims the priority of Chinese Patent Application No. 201510027254.7, filed on Jan. 20, 2015, both of which are hereby incorporated by reference in their entireties.

### TECHNICAL FIELD

The present invention relates to a dual-screen tablet computer and, in particular, to a dual-screen tablet computer display and a touch control method.

### BACKGROUND

Tablet computers, super computers and other electronic products have been increasingly widely used in virtue of portability, lightweight and other features. With the development of electronic technologies and communication technologies, computers have an increasingly faster computing speed and more and more functions can be integrated into light and thin tablet computers. In addition to recreation and entertainment and the like, more and more office needs can be met by tablet computers.

A dual-screen tablet computer is an improvement or a variant of a tablet computer. The dual-screen computer on the market typically uses a rotating shaft to connect its two tablet computers and 180 degrees of opening and closing can be performed between the two tablet computers. Moreover, the tablet computers are typically provided with touch screens and touch control of the tablet computers can be performed through the touch screens.

The technology of using a single touch screen and a display screen to perform touch control of a single tablet computer has been well developed. Currently, a dual-screen tablet computer uses two touch control integrated circuits to control two touch screens, respectively. On the one hand, the hardware costs are high. On the other hand, when two touch screens and two display screens are required for expanded display or touch control or coordinated display or control, the communication and wiring design and the software design between the two touch control integrated circuits become extremely complex. This brings much inconvenience to the system design. Therefore, the two touch screens of a current dual-screen tablet computer are driven separately and are under separate touch control.

For a dual-screen tablet computer provided with two tablet computers and two touch screens, it is urgent to put forward a solution to reduce hardware costs, effectively use computer system software and hardware resources and improve convenience and practicability of display and touch control of the dual-screen tablet computer.

### SUMMARY

One object of the present invention is to reduce hardware costs and improve system operation efficiency of a dual-screen tablet computer.

Another object of the present invention is to increase convenience of display and touch control of the dual-screen tablet computer.

Yet another object of the present invention is to implement separate or expanded display of the two display screens, separate or combined input or output of the two touch screens and separate or joint touch control of the two touch screens of a dual-screen tablet computer.

To achieve the above objects, the dual-screen tablet computer of the present invention includes a first display screen, a second display screen, a first touch screen and a second touch screen. The first touch screen is bonded to the first display screen. The second touch screen is bonded to the second display screen. The first display screen and the second display screen are connected to each other through a rotating shaft or a hinge and may be unfolded or closed. The first touch screen and the second touch screen are electrically connected to a single touch main control module simultaneously.

Preferably, the touch main control module includes a touch mode selection module, which is configured to control the first touch screen and the second touch screen to enter an expanded touch control mode or a separate touch control mode.

Preferably, the dual-screen tablet computer of the present invention further includes a display mode selection module, which is configured to control the first display screen and the second display screen to enter a separate display mode, a mirroring display mode or an expanded display mode.

Preferably, the display mode selection module and the touch main control module of the dual-screen tablet computer of the present invention are electrically connected to the main board control circuit of the dual-screen tablet computer, respectively, and the display mode selection module and the touch mode selection module use the main board control circuit for electric connection and communications.

Preferably, the touch main control module is electrically connected to and communicates with a main board of the dual-screen tablet computer through an independent USB interface.

Preferably, the first touch screen and the second touch screen are electrically connected to the same touch control integrated circuit.

Preferably, the first touch screen includes N first touch sensing electrodes and the second touch screen includes M second touch sensing electrodes. The N first touch sensing electrodes and the M second touch sensing electrodes are sequentially electrically connected to a touch control electrode driver and a scanning interface of the touch control integrated circuit. N and M are natural numbers.

Preferably, the touch control integrated circuit includes a switch selection circuit, which is electrically connected to the N first touch sensing electrodes and the M second touch sensing electrodes. The switch selection circuit chooses to gate the N first touch sensing electrodes and the M second touch sensing electrodes separately or to gate the N first touch sensing electrodes and the M second touch sensing electrodes simultaneously.

Preferably, the touch main control module includes a touch mode selection module, which is electrically connected to the N first touch sensing electrodes and the M second touch sensing electrodes separately and controls the first touch screen and the second touch screen to enter the expanded touch control mode or the separate touch control mode.

The present invention further provides a display and touch control method for a dual-screen tablet computer. The dual-screen tablet computer includes a first display screen, a second display screen, a first touch screen and a second touch screen. The first touch screen is bonded to the first display screen. The second touch screen is bonded to the second display screen. A side of the first display screen and a side of the second display screen are connected to each other through a rotating shaft and may be unfolded or closed. The control method includes: selecting one of preset display modes for the first display screen and the second display screen, and enabling the first touch screen and the second touch screen to enter a preset touch control mode based on the selected display mode.

Preferably, the preset display mode includes one of a separate display mode, a mirroring display mode and an expanded display mode or a combination thereof; and the preset touch control mode includes a separate touch control mode and an expanded touch control mode.

Preferably, when the separate display mode or the minoring display mode is selected for the first display screen and the second display screen, the first touch screen and the second touch screen are enabled to enter the separate touch control mode; and when the expanded display mode is selected for the first display screen and the second display screen, the first touch screen and the second touch screen are enabled to enter the expanded touch control mode.

Preferably, the first touch screen and the second touch screen are driven and scanned by the same touch control module.

Preferably, the display and touch control method for the dual-screen tablet computer drives and scans the first display screen and the second display screen with the same display control module to.

Preferably, in the display and touch control method for the dual-screen tablet computer, the first touch screen includes N first touch sensing electrodes and the second touch screen includes M second touch sensing electrodes. N and M are natural numbers. The N first touch sensing electrodes and the M second touch sensing electrodes are electrically connected to the same touch control integrated circuit. The touch control integrated circuit drives and scans the N first touch sensing electrodes and the M second touch sensing electrodes.

Preferably, when the separate display mode or the minoring display mode is selected for the first display screen and the second display screen, the touch control integrated circuit drives and scans the N first touch sensing electrodes and the M second touch sensing electrodes respectively to enable the first touch screen and the second touch screen to run separately; and when the expanded display mode is selected for the first display screen and the second display screen, the touch control integrated circuit drives and scans the N first touch sensing electrodes and the M second touch sensing electrodes simultaneously.

Preferably, in the separate display mode, the first display screen and the second display screen display separately; in the minoring display mode, the first display screen and the second display screen display the same content; and in the expanded display mode, the first display screen and the second display screen are integrated into one display screen to display content.

Preferably, when the expanded display mode is selected for the first display screen and the second display screen, the first touch screen and the second touch screen enter the expanded touch control mode, the first display screen displays one half of a system desktop and implements touch control of desktop objects through the first touch screen, and the second display screen displays the other half of the system desktop and implements touch control of desktop objects through the second touch screen.

In the dual-screen tablet computer of the present invention, one single touch control integrated circuit or touch main control module is electrically connected to and controls the two touch screens. On the one hand, hardware design costs are reduced. On the other hand, since the same touch control integrated circuit or touch main control module is used, the two touch screens can be controlled based on the same operating system. In this way, when two touch screens are employed for controlling, the two touch screens can conveniently coordinate with the display system to enable separate control or expanded control of the two touch screens and to enable separate display, expanded display, minoring display and other functions of the display screens. This simplifies the software system design, increases the system operating efficiency and improves the user experience.

### BRIEF DESCRIPTION OF DRAWINGS

FIG. 1 is a block structure diagram illustrating touch screens of a dual-screen tablet computer of the present invention.

FIG. 2 is a block structure diagram illustrating touch screens of the dual-screen tablet computer of the present invention according to a second embodiment.

FIG. 3 is a block structure diagram illustrating display screens of the dual-screen tablet computer of the present invention.

FIG. 4 is a block structure diagram illustrating touch screens of the dual-screen tablet computer of the present invention according to a third embodiment.

FIG. 5 is a flowchart illustrating a display and touch control method for a dual-screen tablet computer of the present invention.

FIG. 6 is a flowchart illustrating the display and touch control method for a dual-screen tablet computer of the present invention according to another embodiment.

FIG. 7 is a schematic diagram illustrating a first display screen and a second display screen.

FIG. 8 is a schematic diagram illustrating the first display screen and a first touch screen.

FIG. 9 is a schematic diagram illustrating the second display screen and a second touch screen.

### DETAILED DESCRIPTION

The nouns and terms involved will be explained before embodiments of the present invention are described in detail. It is to be noted that in the present specification, components having the same names or reference numbers denote similar or identical structures and are intended to be illustrative only.

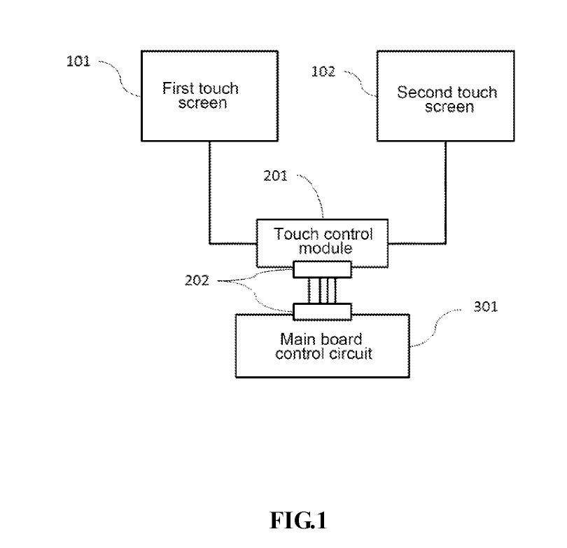

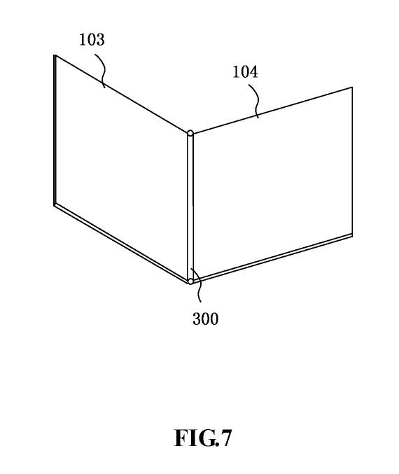

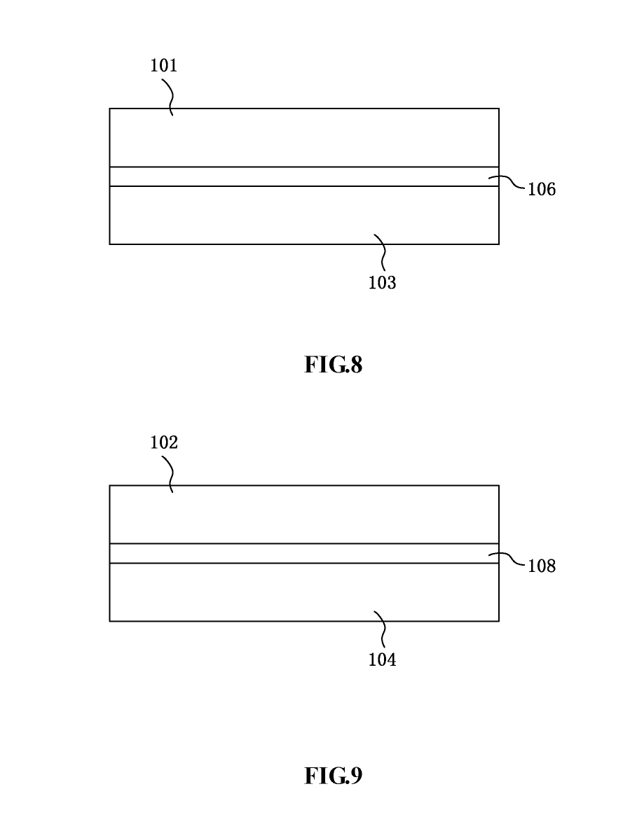

FIG. 1 is a block structure diagram illustrating touch screens of a dual-screen tablet computer of the present invention. The dual-screen tablet computer of the present invention includes a first display screen 103, a second display screen 104 (the first display screen 103 and the second display screen 104 are not shown in FIG. 1), a first touch screen 101 and a second touch screen 102. As shown in FIG. 8, the first touch screen 101 is bonded to the first display screen 103. As shown in FIG. 8, the second touch screen 102 is bonded to the second display screen 104. As shown in FIG. 7, the first display screen 103 and the second display screen 104 are connected to each other through a rotating shaft 300 or a hinge 300 and may be unfolded or folded. The first touch screen 101 and the second touch screen 102 are electrically connected to a single touch main control module 201 simultaneously.

It is to be noted that the first display screen 103 adheres to the first touch screen 101 in a conventional manner. That is, the first touch screen 101 is superimposed on the first display screen 103, with optical adhesive 106 or transparent adhesive 106 adhered therebetween. Display content on the first display screen 103 can be controlled through the first touch screen 101. The second display screen 104 and the second touch screen 102 are configured in the same or similar structures. That is, the second touch screen 102 is superimposed on the second display screen 104 with optical adhesive 108. The first display screen 103, the second display screen 104, the first touch screen 101 and the second touch screen 102 are connected to electronic components therein through flexible circuit boards or cables, and are led out at edges or are electrically connected to each other.

The first display screen 103 and the second display screen 104 are connected to each other through a rotating shaft or a hinge and may be unfolded or folded. It is to be noted that a damping structure may be provided in the rotating shaft and the hinge so as to maintain a certain angle between the first display screen 103 and the second display screen 104 after unfolded. The first display screen 103 and the second display screen 104 described herein have been bonded to the first touch screen 101 and the second touch screen 102 respectively. This description is omitted for convenience of description.

It is to be noted that the “a single touch main control module 201” refers to a same touch control integrated circuit or a combination of software and hardware based on a same touch control integrated circuit. The touch main control module 201 may be embodied by a separate integrated circuit chip, a relatively separate circuit board, or two or more discrete integrated circuit chips or a circuit board containing an integrated circuit chip. Inherently, the discrete integrated circuit chips or the circuit board is based on one and the same touch control core or one and the same touch control central processing system.

In the dual-screen tablet computer of the present invention, a single touch control integrated circuit or touch main control module is electrically connected to and controls the two touch screens. On the one hand, hardware design costs are reduced. On the other hand, since the same touch control integrated circuit or touch main control module is used, the two touch screens can be controlled based on the same operating system. In this way, when two touch screens are employed for controlling, the touch screens can conveniently coordinate with the display system to realize separate control or expanded control of the two touch screens and to realize separate display, expanded display, mirroring display and other functions of the display screens. This simplifies the software system design, increases the system operating efficiency and improves the user experience.

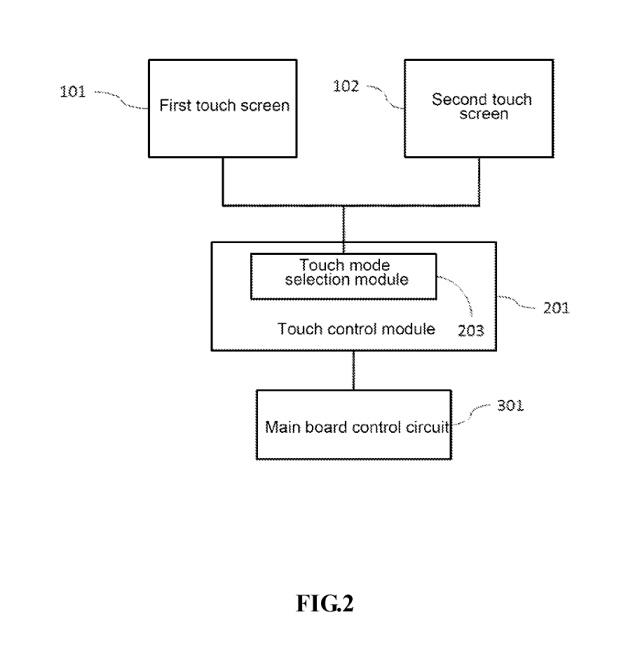

FIG. 2 is a block diagram illustrating the structure of touch screens of the dual-screen tablet computer of the present invention according to a second embodiment. As illustrated in FIG. 2, the touch main control module 201 of the dual-screen tablet computer of the present invention further includes a touch mode selection module 203, which is configured to control the first touch screen 101 and the second touch screen 102 to enter the expanded touch control mode or the separate touch control mode. In the separate touch control mode, the first touch screen 101 and the second touch screen 102 each serve as an independent touch screen and run independently, and drive and scan the touch sensing components independently and separately as follows: one of the touch screens is turned off while the other is turned on, or both the touch screens are turned on or turned off. In the expanded touch control mode, the first touch screen 101 and the second touch screen 102 are combined as one touch screen device to be driven and scanned. Using the horizontal X coordinate axis as an example and assuming that the horizontal X coordinate axis has 100 coordinate points, the first touch screen 101 touch-scans and touch-controls the display objects in the coordinate range from [0, Y] to [50, Y] and the second touch screen 102 touch-scans and touch-controls the display objects in the coordinate range from [50, Y] to [100, Y]. By using the touch mode selection module 203, the present invention enables adjusting and coordination of multiple touch control modes for the first touch screen 101 and the second touch screen 102 in a single hardware or software system, thereby improving user-friendliness of the dual-screen tablet computer and meeting the requirements of display and touch control modes in specific application scenarios.

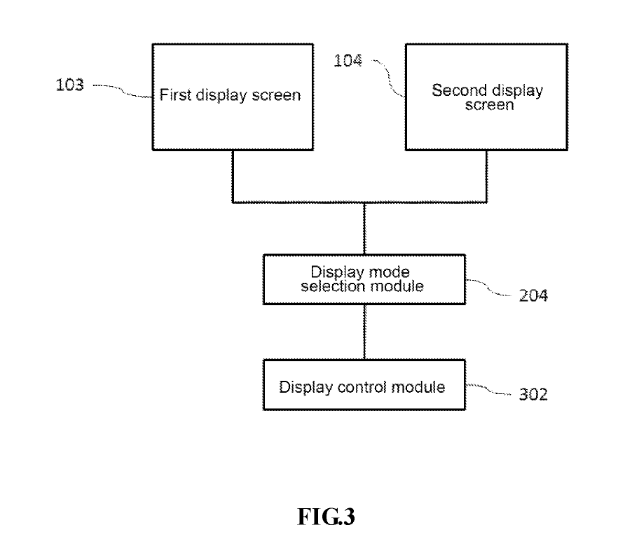

FIG. 3 is a block diagram illustrating display screens of the dual-screen tablet computer of the present invention. As illustrated in FIG. 2 and FIG. 3, the dual-screen tablet computer of the present invention further includes a display mode selection module 204, which is configured to control the first display screen 103 and the second display screen 104 to enter the separate display mode, the mirroring display mode or the expanded display mode. Preferably, the display mode selection module 204 is electrically connected to a display control module 302. The display mode selection module 204 and the touch main control module 201 are electrically connected to a main board control circuit 301 of the dual-screen tablet computer, respectively. The display mode selection module 204 and the touch mode selection module 203 are electrically connected and communicate through the main board control circuit. In the separate display mode, the first display screen 103 and the second display screen 104 display independently. In the mirroring display mode, one of the display screens displays content displayed by the other display screen. In the expanded display mode, the first display screen 103 and the second display screen 104 are combined as one display screen to display content. That is, the first display screen 103 displays one half of content of a computer desktop and the second display screen 104 displays the other half of content of the computer desktop. Multiple display modes of the dual-screen tablet computer are enabled by using the display mode selection module 204, and display and touch control is easier in coordination with the first touch screen 101 and the second touch screen 102.

Moreover, the touch main control module 201 of the dual-screen tablet computer of the present invention is electrically connected to and conducts data communication with the main board control circuit 301 of the dual-screen tablet computer through a single USB interface 202. As a general data signal interface, the USB interface has good compatibility and convenience. The present invention uses the USB interface to connect both the two touch screens to the main board control circuit, facilitating data communications and control of the touch screens and the main board control circuit.

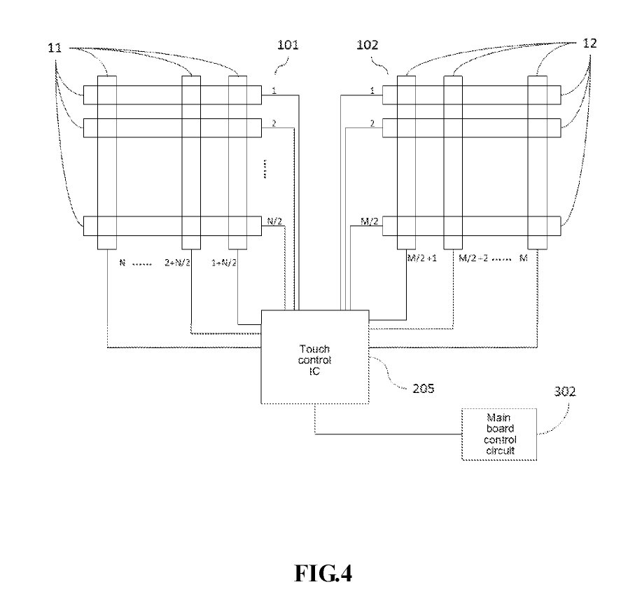

FIG. 4 is a block diagram illustrating structures of touch screens of the dual-screen tablet computer of the present invention according to a third embodiment. As illustrated in FIG. 4, the first touch screen 101 includes N first touch sensing electrodes 11 and the second touch screen 102 includes M second touch sensing electrodes 12. The N first touch sensing electrodes 11 and the M second touch sensing electrodes 12 are electrically connected to touch control electrode driving interfaces and scanning interfaces of the touch control integrated circuit 205. N and M are natural numbers. The values of N and M may be the same or different. As illustrated in FIG. 4, in the first touch screen 101, the first to N/2th touch sensing electrodes 11 are in the horizontal direction and the (N/2+1)th to Nth touch sensing electrodes 11 are in the vertical direction. It is to be noted that the horizontal and vertical directions illustrated in FIG. 4 are examples only. Those skilled in the touch control field may combine and adjust shapes and arrangement of the touch sensing electrodes. The present invention does not limit the touch control sensing modes and specific structures of the touch sensing electrodes. The touch control sensing principles of the second touch screen 102 are the same as the structure of the first touch screen 101 and will not be repeated.

It is to be noted that the N first touch sensing electrodes 11 and the M second touch sensing electrodes 12 may be directly connected to pins of the touch control integrated circuit or be indirectly connected to pins of the touch control integrated circuit through a component like a transit interface or a flexible circuit board or a peripheral circuit like a switch selection circuit. The dual-screen tablet computer of the present invention uses one single touch control integrated circuit to control the first touch screen 101 and the second touch screen 102, thereby enabling free coordination and control between the two display screens and the two touch screens of the dual-screen tablet computer, avoiding software and hardware communications problems brought about by the use of two separate touch control sensing systems, improving user-friendliness and reducing hardware costs.

Preferably, the touch control integrated circuit includes a switch selection circuit. The switch selection circuit is electrically connected to the N first touch sensing electrodes and the M second touch sensing electrodes separately. The switch selection circuit chooses to gate the N first touch sensing electrodes and the M second touch sensing electrodes separately or to gate the N first touch sensing electrodes and the M second touch sensing electrodes simultaneously. Moreover, the touch main control module 201 or the touch control integrated circuit 205 may further include a touch mode selection module 203. The touch mode selection module 203 is electrically connected to the N first touch sensing electrodes 11 and the M second touch sensing electrodes 12 separately and controls the first touch screen 101 and the second touch screen 102 to enter the expanded touch control mode or the separate touch control mode.

In the dual-screen tablet computer of the present invention, one single touch control integrated circuit or touch main control module is electrically connected to and controls the two touch screens. On the one hand, hardware design costs are reduced. On the other hand, since the same touch control integrated circuit or touch main control module is used, the two touch screens can be controlled based on the same operating system. In this way, when two touch screens are used for controlling, the touch screens can conveniently coordinate with the display system to enable separate control or expanded control of the two touch screens and to enable separate display, expanded display, mirroring display and other functions of the display screens. This simplifies the software system design, increases the system operating efficiency and improves the user experience.

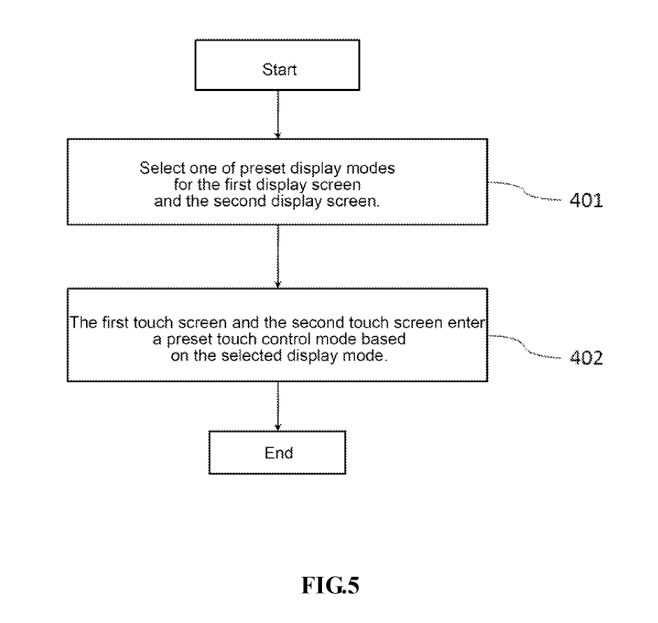

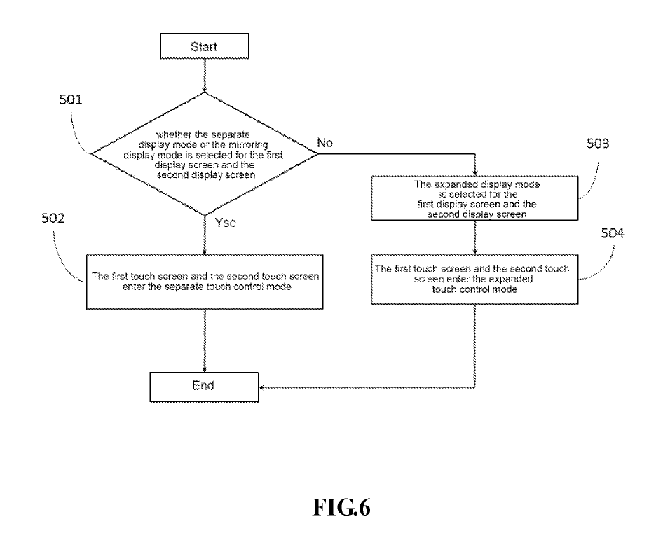

The present invention further provides a dual-screen tablet computer display and touch control method. As illustrated in FIG. 5, the dual-screen tablet computer includes a first display screen 103, a second display screen 104, a first touch screen 101 and a second touch screen 102. The first touch screen 101 is bonded to the first display screen 103. The second touch screen 102 is bonded to the second display screen 104. A side of the first display screen 103 and a side of the second display screen 104 are connected to each other through a rotating shaft and may be unfolded or folded. The control method includes step 401 and step 402. In step 401, one of preset display modes is selected for the first display screen and the second display screen. In step 402: the first touch screen and the second touch screen are enabled to enter a preset touch control mode based on the selected display mode.

It is to be noted that the preset display mode may be configured to include one of a separate display mode, a mirroring display mode and an expanded display mode or a combination thereof; and the preset touch control mode may be configured to include a separate touch control mode and an expanded touch control mode.

The dual-screen tablet computer display and touch control method of the present invention further includes steps 501 through 504.

In step 501, when the separate display mode or the mirroring display mode is selected for the first display screen and the second display screen, go to step 502.

In step 502, the first touch screen and the second touch screen enter the separate touch control mode.

In step 503, when the expanded display mode is selected for the first display screen and the second display screen, go to step 504.

In step 504, the first touch screen and the second touch screen enter the expanded touch control mode.

Furthermore, the dual-screen tablet computer display and touch control method of the present invention may drive and scan the first touch screen and the second touch screen with the same touch control module. The same touch control module may be hardware like a touch control integrated circuit chip, may be a combination of a hardware circuit of a touch control integrated circuit chip and control software thereof or may be a firmware module built in the touch control integrated circuit chip. The electrodes in the first touch screen and the second touch screen are scanned using the most common touch-driving and touch-scanning technologies in the touch control field.

It is to be noted that the dual-screen tablet computer display and touch control method of the present invention uses the same display control module to drive and scan the first display screen and the second display screen. In this way, both display control and touch control are performed in the same system, thereby avoiding possible complex communications and control problems between two systems, reducing hardware costs, improving the system operating efficiency and facilitating the application-level client design.

The dual-screen tablet computer display and touch control method of the present invention may further use the following approach: the first touch screen includes N first touch sensing electrodes and the second touch screen includes M second touch sensing electrodes. N and M are natural numbers. The N first touch sensing electrodes and the M second touch sensing electrodes are electrically connected to the same touch control integrated circuit. The touch control integrated circuit drives and scans the N first touch sensing electrodes and the M second touch sensing electrodes.

Particularly, when the separate display mode or the mirroring display mode is selected for the first display screen and the second display screen, the touch control integrated circuit drives and scans the N first touch sensing electrodes and the M second touch sensing electrodes separately to enable the first touch screen and the second touch screen to run separately. When the expanded display mode is selected for the first display screen and the second display screen, the touch control integrated circuit drives and scans the N first touch sensing electrodes and the M second touch sensing electrodes simultaneously. In the separate display mode, the first display screen and the second display screen display content separately. In the mirroring display mode, the first display screen and the second display screen display same content. In the expanded display mode, the first display screen and the second display screen are combined as one display screen to display content.

The dual-screen tablet computer display and touch control method of the present invention may further includes the following steps: when the expanded display mode is selected for the first display screen and the second display screen, the first touch screen and the second touch screen enter the expanded touch control mode, the first display screen displays one half of a system desktop and implements touch control of desktop objects through the first touch screen, and the second display screen displays the other half of the system desktop and implements touch control of desktop objects through the second touch screen. Those skilled in the art may make various adjustments and modifications with reference to descriptions in the present specification and under technical enlightenment of the present invention.

In the dual-screen tablet computer of the present invention, one single touch control integrated circuit or touch main control module is electrically connected to and controls the two touch screens. On the one hand, hardware design costs are reduced. On the other hand, since the same touch control integrated circuit or touch main control module is used, the two touch screens can be controlled on the same operating system. The dual-screen tablet computer display and touch control method of the present invention enables coordination between different display modes and different touch modes of two display screens and two touch screens in the same system architecture. This satisfies diversified needs of users and particularly applies to music software production, game production, accounting software production and other specific scenarios, thereby greatly improving user-friendliness of the display and touch control interface of the dual-screen tablet computer. When two touch screens are controlled, the touch screens can conveniently coordinate with the display system to enable separate control or expanded control over the two touch screens and to enable separate display, expanded display, mirroring display and other functions of the display screens. This simplifies the software system design, increases the system operating efficiency and improves the user experience.

While the present invention has been described in detail in connection with the preferred embodiments, those skilled in the art may make various partial changes to the specific embodiments of the present invention and may make various adjustments and modifications to forms and details of the present invention without departing from the spirit and scope of the present invention. All these changes, adjustments and modifications are within the scope of the present invention.

What is claimed is:

1. A dual-screen tablet computer, comprising: a first display screen, a second display screen, a first touch screen, and a second touch screen and one touch control circuit;
wherein the first touch screen is bonded to the first display screen; the second touch screen is bonded to the second display screen; the first display screen and the second display screen are connected to each other through a shaft or a hinge such that the dual-screen tablet computer is capable of being folded and unfolded; and when one of preset display modes is selected, the one touch control circuit is configured to cause the first touch screen and the second touch screen to enter a preset touch control mode based on the selected display mode.

2. The dual-screen tablet computer of claim 2, wherein the preset display modes comprises a separate display mode, a mirroring display mode and an expanded display mode; and the preset touch control mode comprises a separate touch control mode and an expanded touch control mode.

3. The dual-screen tablet computer of claim 2, wherein when the separate display mode or the mirroring display mode is selected for the first display screen and the second display screen, the first touch screen and the second touch screen are caused to enter the separate touch control mode; and when the expanded display mode is selected for the first display screen and the second display screen, the first touch screen and the second touch screen are caused to enter the expanded touch control mode.

4. The dual-screen tablet computer of claim 2, wherein the one touch control circuit drives the first touch screen and the second touch screen.

5. The dual-screen tablet computer of claim 2, further comprising one display control circuit for driving the first display screen and the second display screen.

6. The dual-screen tablet computer of claim 2, wherein the first touch screen comprises N first touch sensing electrodes and the second touch screen comprises M second touch sensing electrodes; N and M are natural numbers; the N first touch sensing electrodes and the M second touch sensing electrodes are electrically connected to the one touch control circuit; and the one touch control circuit is configured to drive the N first touch sensing electrodes and the M second touch sensing electrodes.

7. The dual-screen tablet computer of claim 6, wherein when the separate display mode or the mirroring display mode is selected for the first display screen and the second display screen, the touch control circuit is configured to drive the N first touch sensing electrodes and the M second touch sensing electrodes separately such that the first touch screen and the second touch screen run separately; and when the expanded display mode is selected for the first display screen and the second display screen, the touch control circuit is configured to drive the N first touch sensing electrodes and the M second touch sensing electrodes simultaneously.

8. The dual-screen tablet computer of claim 2, wherein in the separate display mode, the first display screen and the second display screen are caused to display independently; in the mirroring display mode; the first display screen and the second display screen display same content; and in the expanded display mode, the first display screen and the second display screen are combined as one display screen to display.

9. The dual-screen tablet computer of claim 2, wherein when the expanded display mode is selected for the first display screen and the second display screen, the first touch screen and the second touch screen enter the expanded touch control mode, the first display screen displays one half of a system desktop, and the second display screen displays the other half of the system desktop.

10. A control method for a dual-screen tablet computer, wherein the dual-screen tablet computer comprises a first display screen, a second display screen, a first touch screen, and a second touch screen and one touch control circuit, the control method comprises:
selecting one of preset display modes, and
causing, by the one touch control circuit, the first touch screen and the second touch screen to enter a preset touch control mode based on the selected display mode.

11. The control method of claim 10, wherein the preset display modes comprises a separate display mode, a mirroring display mode and an expanded display mode; and the preset touch control mode comprises a separate touch control mode and an expanded touch control mode.

12. The control method of claim 11, wherein when the separate display mode or the mirroring display mode is selected for the first display screen and the second display screen, the first touch screen and the second touch screen are caused to enter the separate touch control mode; and when the expanded display mode is selected for the first display screen and the second display screen, the first touch screen and the second touch screen are caused to enter the expanded touch control mode.

13. The control method of claim 11, wherein when the first touch screen and the second touch screen are caused to enter the preset touch control mode, the first touch screen and the second touch screen are driven by the one touch control circuit.

14. The control method of claim 11, wherein when one of preset display modes is selected for the first display screen and the second display screen, the first display screen and the second display screen are driven by one display control circuit.

15. The control method of claim 11, wherein the first touch screen comprises N first touch sensing electrodes and the second touch screen comprises M second touch sensing electrodes; N and M are natural numbers; the N first touch sensing electrodes and the M second touch sensing electrodes are electrically connected to the one touch control circuit;
and the one touch control circuit is configured to drive the N first touch sensing electrodes and the M second touch sensing electrodes.

16. The control method of claim 15, wherein when the separate display mode or the mirroring display mode is selected for the first display screen and the second display screen, the touch control circuit is configured to drive the N first touch sensing electrodes and the M second touch sensing electrodes separately such that the first touch screen and the second touch screen run separately; and when the expanded display mode is selected for the first display screen and the second display screen, the touch control circuit is configured to drive the N first touch sensing electrodes and the M second touch sensing electrodes simultaneously.

17. The control method of claim 11, wherein in the separate display mode, the first display screen and the second display screen are caused to display independently; in the mirroring display mode; the first display screen and the second display screen display same content; and in the expanded display mode, the first display screen and the second display screen are combined as one display screen to display.

18. The control method of claim 11, wherein when the expanded display mode is selected for the first display screen and the second display screen, the first touch screen and the second touch screen enter the expanded touch control mode, the first display screen displays one half of a system desktop, and the second display screen displays the other half of the system desktop.
